(19) United States
(12) Patent Application Publication
(10) Pub. No.: US 2026/0169825 A1
(43) Pub. Date: Jun. 18, 2026

(54) PROVISIONED POLLERS FOR OPTIMIZED CLOUD RESOURCE UTILIZATION

(71) Applicant: Amazon Technologies, Inc., Seattle, WA (US)

(72) Inventors: Rajesh Kumar Pandey, Kenmore, WA (US); Tarun Rai Madan, Seattle, WA (US); Tejas Mahadeo Ghadge, Sammamish, WA (US); Vinayak Sood, Bothell, WA (US); Janak Madhusudan Agarwal, Kirkland, WA (US); Fatehjeet Singh Sra, Seattle, WA (US); Bo Dai, Kenmore, WA (US)

(21) Appl. No.: 18/980,987

(22) Filed: Dec. 13, 2024

(51) Int. Cl. G06F 9/50

(52) U.S. Cl. CPC G06F 9/5083; G06F 9/505; G06F 9/5077

(57) ABSTRACT

A system for polling data may include a client virtual network environment configured to generate or transmit data for further processing; a service function environment configured to execute service functions configured to perform further processing on the data generated or transmitted by the client virtual network environment; and a poller device communicatively coupled to the client virtual network environment and the service function environment. The poller device can include one or more poller instances, each of the one or more poller instances including at least a first environment configured to poll data from the client virtual network environment and a second environment configured to receive data from the first environment and transmit data batches to service functions in the service function environment. The environments of the poller instances can independently scale utilization of computing resources based at least in part on respective workloads of the environments.

### BACKGROUND

Computing devices can utilize networks to exchange data. Users operate networks that interconnect computing systems to support various operations or to provide services to third parties. The various computing systems may locate in a single physical location, or a plurality of physical locations. Specifically, data centers or cloud service centers, hereinafter referred to as a “data center” may include a number of interconnected computing devices to provide computing resources to users of the data center.

To accommodate increased utilization of data center resources and the resulting heavier communication traffic between data centers and other user systems, polling functions allow the system managing the connection between data centers and other user systems to decide the availability of various computing resources and accordingly assign communication workload to available resources. With polling functions, the system managing the connection between data centers and other user systems can monitor the various connections, allocate computing resources based on the workloads, and thus supports multiplexing or inverse multiplexing of connections to accommodate varying workloads or different environments.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a block diagram depicting an illustrative environment in which a poller device can be set up to facilitate data transmission between network environments.

FIG. 2 depicts a general architecture of a computing device providing a poller device of FIG. 1.

FIG. 3 is a flow diagram depicting illustrative interactions for setting up a poller device on computing resources provisioned for a connection.

FIG. 4 is a flow diagram depicting illustrative interactions for utilizing a poller device to transmit data between a client virtual network environment and a service function environment.

FIG. 5 is an illustrative routine for setting up a poller device with provisioned computing resources.

FIG. 6 is an illustrative routine for utilizing the poller device for handling data transmission workload.

FIG. 7 is a flow diagram depicting illustrative interactions for scaling usage of computing resources.

### DETAILED DESCRIPTION

Generally described, aspects of the present disclosure relate to handling data transmission between network environments. Users of remote computation services can set up connections between cloud services and predesignated sources of data, for example, the user's virtual network environment. The computed results can then be transmitted, via the connection, to predesignated destinations where the results can be further utilized for various applications. Such a connection infrastructure enables users and users'devices to remotely access computational resources which are not locally available. However, such connections often span multiple networks and various devices, leading to multiple rounds of inter-network transactions among devices with various working conditions within a single round of cross-connection communication. To handle this transaction overhead, a connection infrastructure may deploy a polling function to facilitate data movements within the connection. A polling function may, for example, check computation requests generated at the sources of data, find an available computation service worker, and transmit the request to the available worker. Similarly, the computation results may be sent back, via the polling function, to a designated destination.

In some conventional designs, the polling function described above may be implemented as instances of a service function, internal to a service function environment (e.g., a network environment storing and executing user-designated instructions to conduct the needed computations). The instances of the polling function may poll, through a network connection, data from a data source residing in a client virtual network environment and send the polled data to the targeted service functions (e.g., invoking the functions), which, like the instances of the polling function, reside in the service function environment. This design comports well with computational environments where the workload is symmetrical and relatively constant. Workloads can be considered symmetrical when the number of invoking calls roughly matches the number of polling calls. However, there are two potential inefficiencies related to the deployment and design of such a polling function. First, different polling functionalities may require different amounts of computational resources at a given time, the amount of which can vary according to the kind and the number of workloads the function handles and the environments the function operates in. When the overall demand for computational resources is high among operating units within the service function environment, the design of such polling function can lead to contentions for computing resources and result in delays for resolving the contentions. Second, the various functionalities may cause multiple communication transactions both within and across the boundary of the network environment in which polling function resides. In an illustrative example, for a polling function that resides in the network space of a data center, any communication reaching outside of the data center necessarily involves a transaction crossing the network boundary of the data center. In another illustrative example, a polling function residing in the client virtual network environment, when requesting more resources, may create conflict for computing resource access vis-à-vis other functionalities residing in the client virtual network environment.

In some existing designs, a solution may exist where the polling function can automatically spawn/terminate instances of polling function to provide additional parallel computing resources when the traffic is high and terminate resources when the traffic is low. The automatically spawning/terminating method works well in environments where workload is symmetrical and light-weighted. However, when a polling function instance is spawned, a set amount of computing resources (and time required to spawn) is pre-determined without accounting for potential adjustments based on the actual needs of the polling function's sub components. First, for many computational work environments, the increases in the workload can be both abrupt and unpredictable, leading to extra lag time where the polling function responsively spawning up new polling instances. Second, the various functionalities within the polling function itself, for example, the functionality of polling data from sources, of invoking computations services, and of workload assignment may asynchronously experience different workloads. Thus, the automatically spawning/terminating design for the polling function may ill suit the workload pattern in some computational work environments. Illustratively, in the automatically spawning/terminating design, the poller function may experience an increase in the number of invoking calls it needs to make while the number of polling calls decreases or remains low. In response to the increasing invoking call workload, the poller function may increase the number of polling function instances/threads to upscale its computing resource usage. However, in these new instances, the polling functionality remains idle, thus creating a waste of computing resources.

In certain existing designs for poller deployment, in order to reduce the transaction overhead across the connection, the polling function may be positioned within the network boundary of the cloud services or operated as an instance of the cloud services. A similar solution may also place the polling function within or close to the boundary of a client-owned network where data is generated or processed data is received. Either way, while transaction overheads (e.g., network hops, API requests, encryption overheads) within the service/client network are reduced, the respective networks'computational resources become further burdened by the scaling needs of the polling function. For example, in the existing designs described above where the polling function is implemented as instances in the service function environment, while communication with other service functions can be implemented as a shared data stream, shared data stores, or direct HTTP calls, thus reducing the number of hops and transaction overheads related to the communication, scaling the polling function requires allocation of computing resources which may also be requested by other service functions in the same environment. Illustratively, running a data-intensive program that involves invoking multiple functions in coordination with one another (e.g., a web-based recommendation system) may cause each of the polling functions and the coordinating functions to upscale its resource usage in the service function environments as more data needs to be polled from sources and more processing gets demanded around the same time. The result will be computing resources contention and potential delays. Moreover, communications to the opposite end of the connections now generate more network hops and redirections, as the first step is always crossing the current end's network boundary.

Embodiments of the present disclosure address these problems by deploying a poller device with provisioned computational resources, between the client virtual network environment and the service function environment. In certain such embodiments, the poller device can be deployed external to the endpoint environments. In some embodiments, a poller device with provisioned computational resources is also called a provisioned poller or a provisioned poller device. As disclosed herein, within the poller devices, different environments may be configured to separately carry out the functionalities of a polling function, illustratively including invoking, polling, and workload managing. The poller device may further be configured to connect to the client and the service environments through private connections. A poller device as described herein provides numerous technical advantages for managing resources in a cloud network, including, but not limited to, independent scalability, targeted and granular control of computational resources, and fewer transaction overheads. As the polling function is moved to a poller device with its own computational resources, this framework enables the poller device to scale its resource usage without burdening either the client virtual environment or the service function environment. Moreover, the poller device can enable more granular scaling policies for the numerous environments in the poller device to independently scale according to the varying workloads without further complicating the resource access management. At the same time, the poller device can reduce communication overheads by establishing private connections to the endpoint environments, with different environments in the poller device assuming communicative credentials of the endpoint environments, thus reducing communicative overheads like encryption overhead, routing latency, and steps of access control. Illustratively, given the functional divisibility of its subsidiary environments, a poller device can enable communicative credential management in complicated network environments by, for example, setting up a poller agent environment to manage and pass the credentials to other functional environments that are establishing the connections. As will be described in greater detail below, an independent credential-managing environment in turn allows the poller device to preserve communicative efficiency even if it is placed within the network boundaries of endpoint environments. By assuming the communicative credentials of the endpoint environments, the poller device can communicate with the endpoint environments without adding, for example, extra encryption overheads and authentication protocols in every round of communications.

For example, in environments where workloads tend to cluster around certain “rush hours,” a poller device may upscale its usage of the provisioned computational resources without creating conflicts with the client and service function environments. Illustratively, if multiple users start requesting the same computationally intensive service from the service function environment during the rush hours, the client environment, the poller device, and the service function environment may each upscale resource usage without being burdened by functions with different resource demands. For example, if the poller device shares computing resources with the service function environment, then the increased resource usage of service functions may impair the poller device from having access to increased computing resources. Such conflicts may take forms as, for example, service functions utilizing all available memory space, exhausting bus bandwidth for internal data transmission, or substantively consuming all processing power provisioned by available processing units.. Similarly in an illustrative environment where the workload is a mixture of metrics updates and computation-heavy, multistep processing of queues, a poller device with different functional environments can independently scale the resource usages of its invoker and polling environments, as the numbers of invoking calls and polls can substantially fluctuate depending if it is a simple update, or multi-step computations involving rounds of invoking several calls per item from the queue.

In addition to enabling independent scaling for different functionalities, a poller device may enable the user to specify a number of provisioned computational resources as the baseline resources the poller device may utilize without sacrificing resource availability at either the client or the service function environment. In an illustrative environment, an emergency condition may trigger abrupt and unpredictable data transmission workload for the connection between the service function environment and the client environment, as multiple requests may be generated around the same time. In such a case, provisioned baseline resources provide desirable redundancy to handle the abruptly increasing workload without causing extra lag time to set up new resources in an ad hoc manner. In some embodiments, the baseline resource is greater than zero. For example, at least one processing unit and at least one memory are provisioned as the baseline resource for the poller device. In some embodiments, the baseline resource is equal or greater than an amount sufficient to handle a sudden increase in workload without causing extra time to set up a new resource. The user, for example, may set up a baseline number of processing units (e.g., CPUs, or GPUs), a baseline number of memory (e.g., DRAMs, or RRAMs), and/or a baseline number of communication channels (e.g. virtual private networks/connections) for the poller device even if the device's current workload is not utilizing all the provisioned resources.

In some embodiments of the present disclosure, the poller device may enable a user to indicate a maximum amount of computing resources provisioned for the connection. In some illustrative environments, sudden workload surges may cause heightened demand for computing resources and, in a poller function design that does not allow capping at a maximum amount of computing resources provisioned, result in undesirable waste and inefficiencies. The resulting waste and inefficiencies, illustratively, may include frequent thermal throttling and hardware degradation. These waste and inefficiencies may be undesirable, for example, in environments where real-time responsiveness is not a high priority like a cold storage workload.

In some embodiments, the poller device is connected to a client virtual environment and a service function environment through designated private connections. In an illustrative workflow, a connection between a client virtual environment and a service function environment may be set up and the poller device is created with communication credentials with both environments. In some embodiments, a poller agent environment in the poller device may be configured to manage such credentials and pass such credentials to environments establishing private connections to the end environments. The poller device environments may in turn establish private connections to both the client and the function environments, so that when a computation request or a calculated result is transmitted through the poller device, fewer cross-network transaction overheads are generated. The poller agent environment may further be implemented to periodically monitor the communicative credentials and update the credentials to main trusted connections to the endpoint environments. In some other embodiments, the connection between the poller device and the end environments may also be implemented as public connections with controlled access.

In some embodiments, the destination of the processed data may reside in a different environment than the client virtual environment. In such a situation, the poller device that operates in a poller environment that is separate from the client virtual environment is able to manage its own communicative credentials and thereby better able to perform data transmission. For example, in some embodiments, the poller agent environment may manage various communication credentials for environments the poller device is instructed to connect to, for example, a destination environment different from a user virtual network environment. The poller agent environment may monitor connection conditions and, for example, update credentials to maintain private connections without resorting to another monitoring or record-keeping system sitting in a different environment. Since the more environments the poller device needs to connect to, the more communicative credentials the poller device needs to maintain, deploying an internal poller agent environment on the poller device helps reduce the communicative overheads to reach a monitoring system sitting in a different environment. Moreover, a poller device design is uniquely suited to manage more communicative credentials since the poller agent environment itself may further burden endpoint environments'computing resources if implemented as a part of the endpoint environments, complicating the resource contention issue for the existing designs. Thus, such a poller agent environment is desirable as more connections to different environments are established and more metadata is generated.

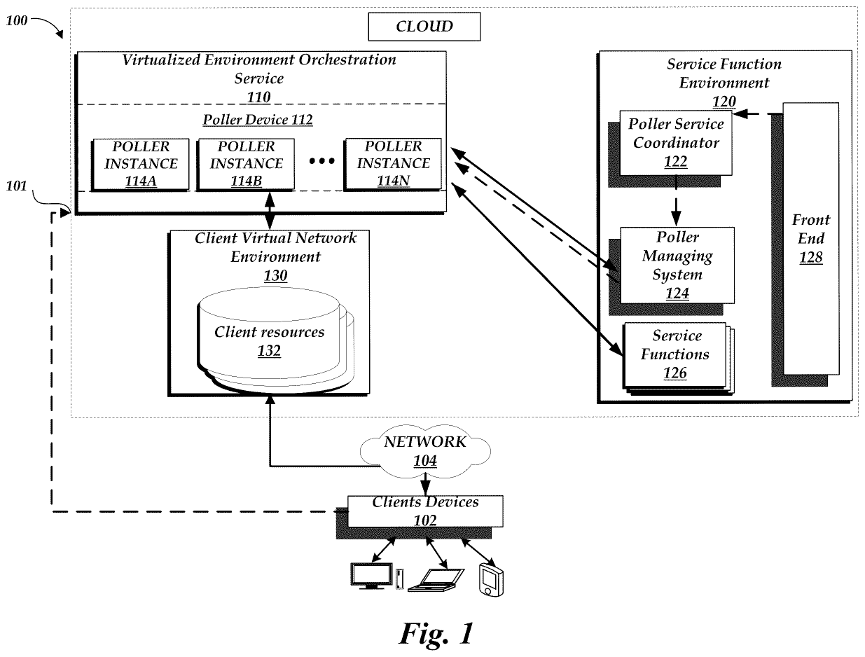

FIG. 1 is a block diagram of an illustrative operating environment 100 for a poller device 112, in which a number poller instances 114 facilitate connection for data transmission between a client virtual environment 130, and a service function environment 120. Both environments illustratively reside in cloud space 101. The data transmission process is illustrated as logical blocks connected with solid arrows while the set-up call process is illustrated as blocks connected by dotted arrows. Each process will be further explained below.

By way of illustration, various example client devices 102, including a desktop computer, a laptop, and a mobile phone, are shown in communication with the client virtual environment 130. In general, the client devices 102 can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like. The client virtual environment 130 may provide the client devices 102 with one or more user interfaces, command-line interfaces (CLI), application programming interfaces (API), and/or other communicative interfaces for generating and uploading user-inputs related to online computations (e.g., a request for online computation, data that needs further processing, and metadata regarding the user device status). Although one or more embodiments may be described herein as using a user interface, it should be appreciated that such embodiments may, additionally or alternatively, use any CLIs, APIs, or any communicative interface.

The client virtual network environment 106 further includes one or more client resources 132 which, upon receiving user-inputs from the user devices 102, may convert the inputs into formats for further processing in the cloud. The client resources 132 may, additionally or alternatively correspond to data storage media where inputs and requests are queued, pending transmission/further processing in, for example, a “first-in-first-out” (“FIFO”) order or an order that is more closely adapted to the working environment. In some instances, the client resources 132 actively transmit data, for example, computation request or data that needs further processing to the poller device 112. In other instances, client resources are passive, such that the data on the queue is periodically polled by the poller device 112. While depicted in FIG. 1 as distinct from the user devices 102, in some embodiments, various functionalities of the client resources 132 as described herein may be carried out by the user devices 112.

After the initial processing at the client virtual network environment 106, the various user inputs will be transmitted to the poller device implemented in a virtualized environment orchestration service 110. The virtualized environment orchestration service 110 may support various virtualized computational environments (e.g., containerization services or virtual machines). The poller device 112 may be implemented as a virtualized computational environment, or alternatively, a host of computational environments in coordination. In some embodiments, the virtualized poller device 112 is configured to scale its computing resource usage by spawning multiple instances of the poller device 114 to accommodate, for example, heightened workloads and different connection routing. The poller device 112 may be configured to communicate with various functions in the service function environment 120.

The service function environment 120 may further include a poller managing system 124. In some embodiments, the poller managing system 124 is implemented as a service function, or a host of service functions in coordination. Although depicted in FIG. 1 as a subcomponent of the service function environment, in some other embodiments, various functionalities of the poller managing system 124 may be implemented on, for example, a different server or environment than the service function environment 120. The poller managing system 124 creates and keeps records of workload assignments for the poller instances 114, monitors operational status of the poller device 112, and manages communicative credentials for the poller device 112. It should be appreciated that each of the functionalities of the poller managing system 124 described herein may be implemented as a different function in the service function environment and each communicative direction (e.g., polling versus pushing the workload assignments) can be altered in implementations according to the specific operational environment. The poller managing system 124 polls operational status data from the poller device 112, and based on the status data, determines if poller instances 114 need to be created or released. For example, new instances 114 may be created when CPU/memory utilization rate exceeds a threshold, or when the number of congesting assignments exceed a certain limit. In some embodiments, the poller device 112 is implemented to make the decision to create new instances and in those embodiments, the role of the poller managing system 124 may be limited to keep record of assignment status. In some other embodiments, the decision logic is separately implemented in the poller device 112 and the poller managing system 124. Similarly, the poller managing system may create and assign workload assignments to the poller device 112 and the poller instances 114 based on their operation status information. In some embodiments, the workload assignment contains information regarding the poller instance 114 receiving the assignment (e.g., the ID of the poller instance 114), the status information of the assignment (e.g., the operational state and the amount and the kind of workload), and the connection between the client virtual network environment 130, the service function environment 120, and targeted service functions 126.

In response to receiving/polling the workload assignment from the poller managing system 124, the poller device 112 and the poller instances 114 start polling data from the client virtual network environments according to the workload assignments. In some embodiments, the poller device 124 may be further configured to divide the polled data into small batches. The poller instances 114 then invoke the targeted service functions 126 and feed the polled data to the targeted service functions 126 according to the workload assignments via private or controlled public connections. The service functions, for example, a serverless compute function, upon receiving the invoking call and the transmitted data, start processing according to the pre-configured programs stored in the service function environment 120. Data processed by the service functions 126 is then transmitted back to the destination, which may illustratively be implemented as a part of the client virtual network environment 130, via the poller device 124 following a similar workflow to the data transmission process previously disclosed.

A frontend 128 may further be implemented in the service function environment 120 to receive a user request to set up a connection between the client virtual network environment 130 and the service function environment 120. The front end 128 may be implemented as various communicative interfaces, including, for example, CLIs, or APIs as previously disclosed. The front end 128 is implemented to communicate with a poller service coordinator which, in response to the connection request, generates an event source mapping (“ESM”) request. In some embodiments, an ESM request details the addresses of the source of various data (e.g., an event or a request), the source instance ID, and the source network interface type. In some embodiments, the mapping may further contain information regarding the service endpoints (e.g., a service function) including the endpoint address, service type, service owner, and the ports for connection (e.g., a HTTPS port). During the processing of a request to establish a connection, the poller managing system 124 is configured to receive ESM information from the poller service coordinator 122. The poller managing system 124, in response to receiving the ESM information, looks up its records of active poller devices 112 to determine if a connection between the source and the service endpoints already exists. If not, the poller system 122 sends a request to the virtualized environment orchestration service 110 to establish a new poller device 112 facilitating the connection between the designated event source and the service endpoint. In some embodiments, the poller system then passes the communicative credentials to the new poller device 112 to establish connections with the source and endpoint environments.

In some embodiments, the connection request further contains an indication of a range of amounts for computing resources provisioned to the requested connection. The range, for example, includes a baseline number of CPUs, GPUs (or a minimum number), memory units, and communicative ports/bandwidth that are initialized along with the requested connection. The range may further include a maximum number for the previously described resources such that no scaling policy may bring the resource usage of the connection and the poller device 112 facilitating the connection beyond the specified amount. The indication of the range is further passed to the virtualized environment orchestration service 110 so that the poller device is initialized on computing resources allocated according to the range. For an illustrative example, a poller device 112 comprises the runtime environment of an image of the poller device program initialized within a Docker container; the container is, per an indication of a range, configured with at least 1GB of memory and 1024 CPU shares and at most 4GB of memory and 2048 CPU shares.

The user devices 102 are connected to the client virtual network environment 130 and the service function environment 120 through a network 104, which may include any wired network, wireless network, or combination thereof. For example, the network 104 may be a personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some embodiments, the network 104 may be a private or semi-private network, such as a corporate or university intranet. The network 104 may include one or more wireless networks, such as a Global System for Mobile Communications (GSM) network, a Code Division Multiple Access (CDMA) network, a Long Term Evolution (LTE) network, or any other type of wireless network. The network 104 can use protocols and components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

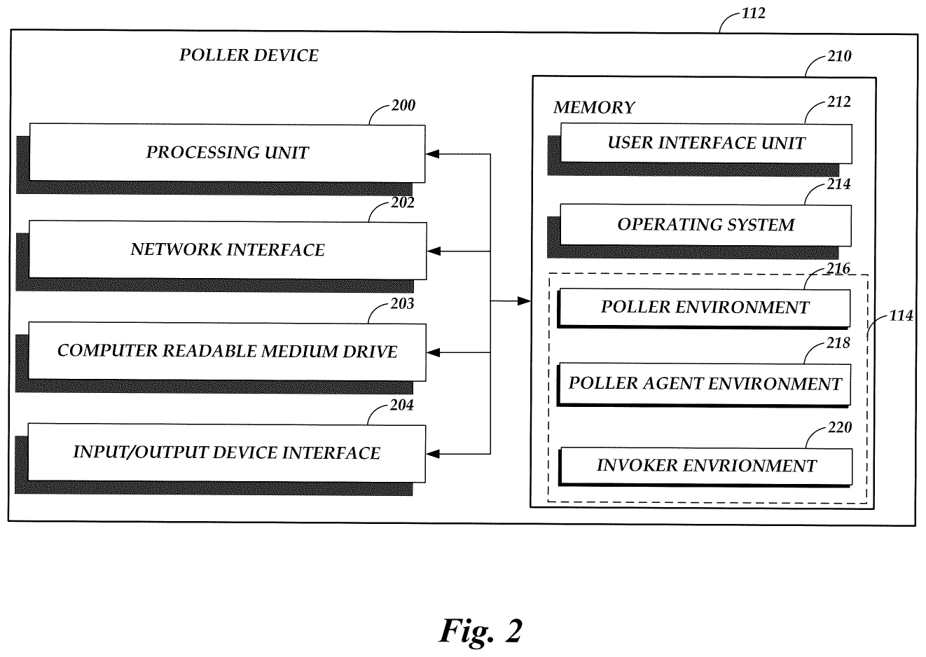

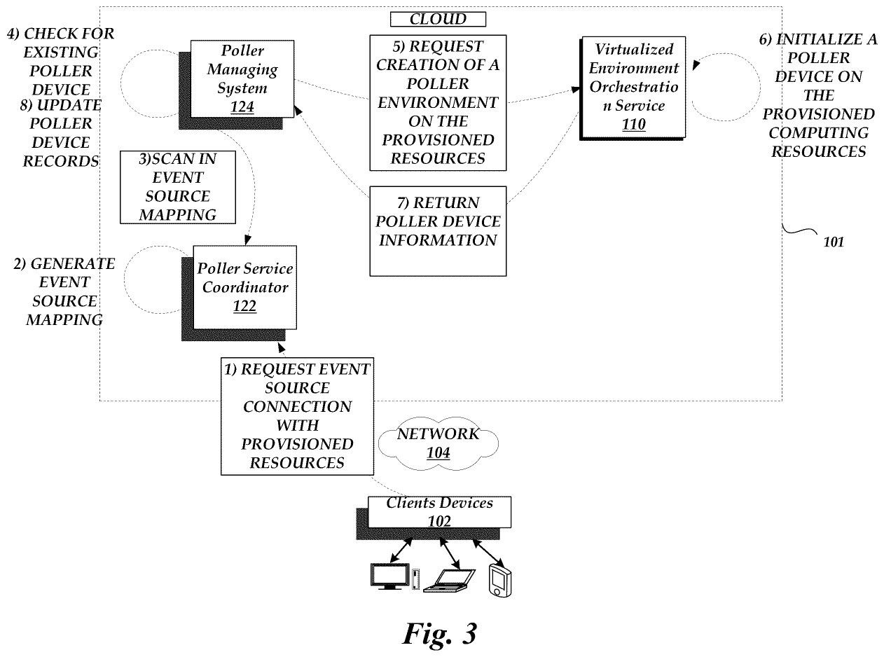

FIG. 2 illustratively depicts general architecture of a computing device providing a poller device 112 depicted in FIG. 3. The general architecture of the poller device 112 depicted in FIG. 3 includes an arrangement of computer hardware and software modules that may be used to implement aspects of the present disclosure. The hardware modules may be implemented with physical electronic devices, as discussed in general detail below. The poller device 112 may include many more (or fewer) elements than those shown in FIG. 3. It is not necessary, however, that all of these generally conventional elements be shown in order to provide an enabling disclosure. Additionally, the general architecture illustrated in FIG. 3 may be used to implement one or more of the other components illustrated in FIG. 1. As illustrated, the poller device 112 includes a processing unit 200, a network interface 202, a computer-readable medium drive 203, and an input/output device interface 204, all of which may communicate with one another by of a communication bus. The network interface 202 may provide connectivity to one or more networks or computing systems via the network 104, or the cloud space 101. The processing unit 200 may thus receive information and instructions from other computing systems. The processing unit 200 may thus receive information and instructions from other computing systems or services via the network 104 or the cloud space 101. The processing unit 200 also communicates to and from memory 210 and further provide output information for an optional display (not shown) via the input/output device interface 204. The input/output device interface 204 may also accept input from an optional input device (not shown).

The memory 210 may contain computer program instructions (grouped as modules in some embodiments) that the processing unit 200 executes in order to implement one or more aspects of the present disclosure. The memory 210 generally includes random access memory (RAM), read only memory (ROM) and/or other persistent, auxiliary or non-transitory computer readable media. The memory 210 may store an operating system 214 that provides computer program instructions for use by the processing unit 200 in the general administration and operation of the poller device 112. The memory 210 may further include computer program instructions and other information for implementing aspects of the present disclosure. For example, in one embodiment, the memory 210 includes a user interface unit 212 that generates user interfaces (and/or instructions therefor) for display upon a computing device, e.g., via a navigation and/or browsing interface such as a browser or application installed on the computing device. In addition, the memory 210 may include and/or communicate with one or more data repositories (not shown), for example, to access user program codes and/or libraries.

Although depicted in FIG. 3 as singular hardware modules, the hardware components including, for example, processing interface 200, network interface 202, and the memory 210 may be virtualized hardware resources, potentially spanning multiple physical hardware pieces grouped together to offer various functionalities as a single hardware unit. In some embodiments, such virtualized hardware resources further correspond to or constitute part of the computing resources provisioned to the connection as previously disclosed.

In addition to and/or in combination with the user interface unit 212, the memory 210 includes a poller environment 216, a poller agent environment 218, and an invoker environment 220. Together, the three environments, when operated by the processing unit 200, constitute a poller instance 114. In one embodiment, the poller environment 216, the poller agent environment 218, and the invoker environment 220 individually or collectively as the poller instance implement various aspects of the present disclosure. For example, the poller environment 216 represents code executable to poll data from the client virtual network environment 130. The invoker environment 220 represents code executable to invoke a service function in service function environment 120 and pass data received from the poller environment 216 for processing and receiving responses from the service functions 116. The poller agent environment 218 obtains and parses metadata and metrices generated by the poller environment 216 and the invoker environment 220. Based on the parsed metadata and operational metrices, the poller agent environment 220 then publishes the metadata to the poller managing system 124 and controls the behavior of the poller environment 216 and the invoker environment 220.

With reference to FIG. 3, illustrative interactions are depicted for setting up a poller device 112 on computing resources provisioned for a connection according to some embodiments. The interactions provide a more detailed depiction of the set-up call illustrated by the dotted arrows in FIG. 1. Specifically, FIG. 3 depicts concerted operations of the poller service coordinator 122, the poller managing system 124, and the virtualized environment orchestration service 110 establishing a poller device 112 on provisioned computing resources.

As shown in FIG. 3, at step (1) a request to establish a connection is initiated from the client devices 102. Illustratively, the request may be created by an application running on the client device 102 or a user input demanding data processing by service functions 126 sitting in the service function environment 120. The request to establish the connection, potentially including information regarding the kind of data processing needed and the address of the client device 102 is then be transmitted to the poller service coordinator 122 implemented in, for example, the service function environment 120. In some embodiments, the request or a separate request initiated by the user devices 102 indicates a range of amounts of the computing resources provisioned for the requested connection. At step (2), the poller service coordinator processes the request to generate an ESM request, attaching information as previously described, potentially including the addresses of the client virtual network environment 130, and the service functions 126 that match the type of service requested by the user. The poller service coordinator 122 then makes the generated ESM request available to the poller managing system 124 by placing it, for example, in a queue of ESM requests. In some embodiments, the ESM request or a separate request associated with the ESM further contains the indicated range of amounts for the provisioned computing resources. At step (3), the poller managing system 124 scans the queue of requests to fetch an ESM request in a predesignated order like, for example, a first-in-first-out order or an order that better suits the computational environment. The poller managing system 124 then checks its records of connections and available poller devices 112. If there is not an active poller device 124 that is facilitating the ESM connection, the poller managing system generates a request to initialize such a poller device.

In some embodiments of the current disclosure, the request generated by the poller managing system 124 also contains the indicated range of amounts of computing resources provisioned for the ESM connection. In some embodiments, even if there is an active poller device 112 currently facilitating the ESM connection, if the amount of provisioned resources does not match with the range in the new request, the poller managing system 124 may generate an update request. At (5), the generated request (or requests) is transmitted to the virtualized environment orchestration service 110. The virtualized environment orchestration service 110 then initializes a certain amount of computing resources with an image of the poller device 112 program at step (6). In some embodiments, the virtualized environment orchestration service 110 allocates a baseline amount of computing resources on which the poller device 112 is initialized if an indication of the baseline amount has been provided at step (5), for example, as a part of an indicated range. After a poller device has been initialized, at step (7) the virtualized environment orchestration service 110 returns the information of the poller device 112 to the poller managing system 124. The information may illustratively include a unique identifier for the poller device 112, the source and endpoint addresses of the ESM connection that the poller device 112 is facilitating, and metadata regarding the operational conditions of the poller device 112. In some embodiments, the poller managing system updates its records of the poller devices 112 according to the returned information.

In some embodiments, a poller instance 114 is spawned as part of the set-up call before any workload assignment is created (not shown).

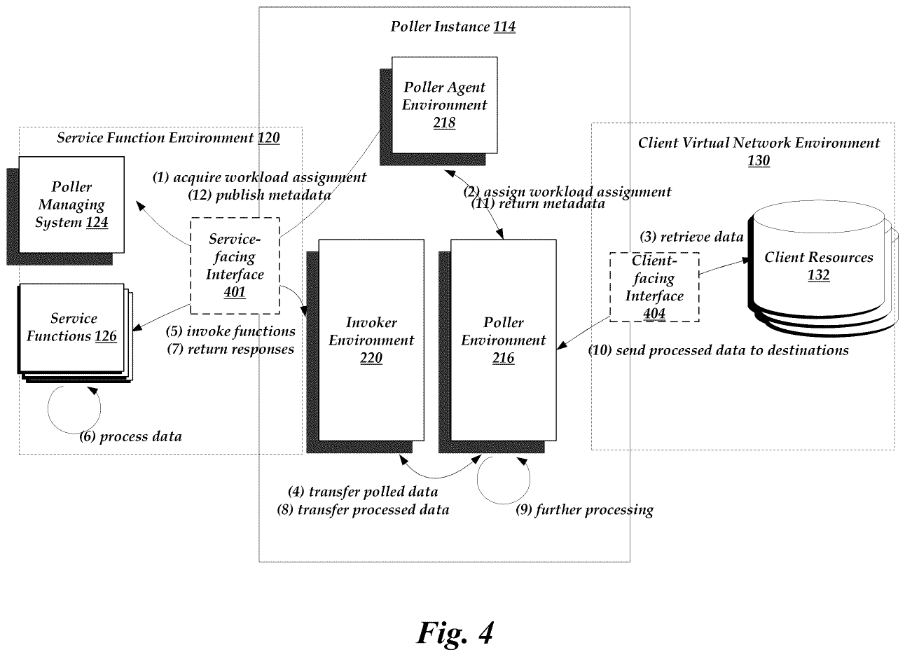

FIG. 4 is a flow diagram depicting illustrative interactions for utilizing a poller device to transmit data between a client virtual network environment and a service function environment. The interactions provide a more detailed depiction of the data transmission illustrated by the solid arrows in FIG. 1. Specifically, FIG. 4 depicts operations of the poller instance 114 facilitating data transmission between the client virtual network environment 130 and the service function environment 120. It is assumed in FIG. 4 that an ESM connection as previously described has already been established and a poller device 112 has been initialized. It is further assumed that at least one poller instance 114 has been spawned on the poller device 112.

At step (1), the poller instance 114 acquires workload assignment generated at the poller managing system 124. The transmission of the workload assignment, and all subsequent communications between the poller instance 114 and the service function environment 120 are, in some embodiments, carried through a service-facing interface 401 which is implemented as, for example, a private connection or a public connection with controlled access. Communicative credentials are then assumed by the poller instance 114 to establish the service-facing interface 401 and the poller agent environment 120, in some embodiments, manages the various communicative credentials acquired from the poller managing system 124 (not shown). Similarly, a client-facing interface 404 is established to connect to communicate with the client virtual network environment 130. At step (2), the poller agent environment 218 assigns certain workload to the poller environment 216 based on the operational status of the poller environment 216. In response to the workload assignment, the poller environment 216 starts polling data from the client resources 132 via the client-facing interface 404 at step (3). Then at step (4) the polled data is transferred to the invoker environment 220, which, in turn, invokes the targeted service functions 126 by feeding the polled data to the functions 126 at step (5). The service functions 126, in response to the invoking call and the transmitted data, start processing the data according to the predesignated function logic at step (6). Upon the completion of the processing of the data, the processed results are sent by the service functions 126 back to the invoker environment 220 as responses, which then forwards the responses to the poller environment at step (8).

In some embodiments, the responses may further include information regarding the state of the service functions, or status of the results, which may be a failure or success indicator. If a failure indicator is received by the poller instance 114, in some embodiments a retry logic may be implemented to decide, for example, the number of attempts to retry the invocation before returning a failure indicator to the user (not shown). The poller environment 216 may then conduct some further processing, including, for example, data validation, format conversion, and/or data merging at step (9) before sending the processed data to the destination at step (10).

Although in FIG. 4 it is assumed that the destination resides in the same space as the client resources, the destination may, in some embodiments, reside in a different environment than the client virtual network environment 130 (not shown). At step (11), metadata regarding the operational status of the poller environment 216, that of the invoker environment 220, the status of various assignments (e.g., completed, pending, or failed) is transmitted to the poller agent environment 218. That metadata is then published to the poller managing system for recording at step (12). In response to the metadata, the poller agent may be further configured to instruct the poller environment 216 to scale its resource usage, by, for example, spawning more instances, or using more computing resources (not shown). Additionally, or alternatively, invoker environment 220, and the poller environment 215 each contains its own scaling logics that decide if scaling is needed (not shown).

In some embodiments of the current disclosure, the invoker environment 220, and the poller environment 216 may be respectively implemented within the network boundaries of the service function environment 120, and the client virtual network environment 130, sharing the address spaces of the respective environments. In such embodiments, the provisioned computing resources are allocated to the client virtual network environment 130 and the service function environment 120 and images of the poller environment 216 and the service function environment 220 are respectively initialized on the allocated computing resources. In some other embodiments, the poller environment 216 and the invoker environment 220 are still implemented on the virtualized environment orchestration service 110 and communicate to the client virtual network environment 130 and the service function environment 120 through private connections. In these embodiments, address space sharing may illustratively be realized through address virtualization (e.g., adding an extra step of redirection so that virtually the environments use addresses from the same space while sitting on different networks/hardware environments).

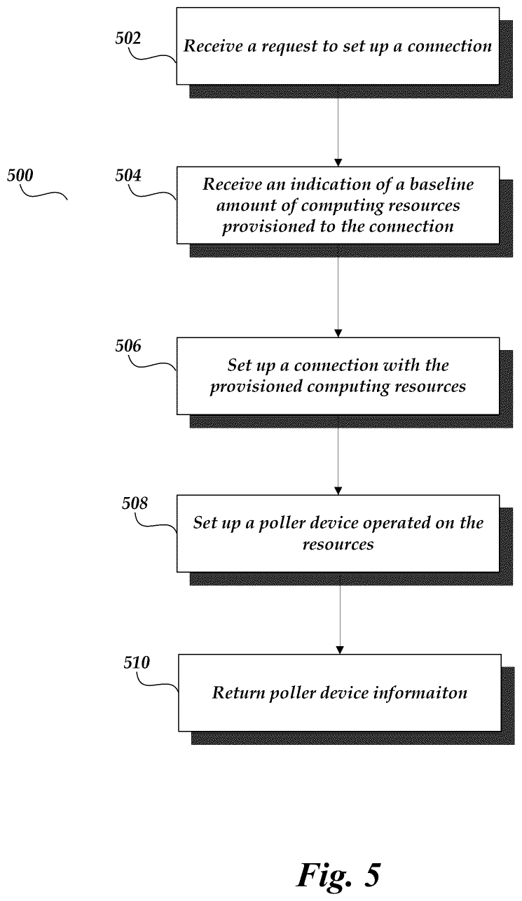

With reference to FIG. 5, an illustrative routine 500 will be described for setting up a poller device on computing resources provisioned for a connection. The routine 500 is implemented, for an illustrative example, by the coordinating the poller service coordinator 122, the poller managing system 124, and the virtualized environment orchestration service 110.

The routine 500 begins at block 502, where the poller service coordinator 122 receives a request to set up a connection. At block 504, the poller service coordinator 122 determines a baseline amount of computing resources provisioned for the requested connection. Determining a baseline amount of computing resources can include, for example, receiving an indication of the baseline amount or setting a baseline amount that is based at least in part on an indication of the baseline amount, which can be supplied by a user. In some embodiments, the indication received at block 504 is implemented as a part of the request at block 502. In response to receiving the request to set up a connection and the indication of a baseline amount of computing resources provisioned to the connection, the poller coordinator may generate an ESM request. In some embodiments, the ESM request details the addresses of the source of various data (e.g., an event or a request), the source instance ID, and the source network interface type. In some embodiments, the ESM request may further contain information regarding the service endpoints (e.g., a service function) including the endpoint address, service type, service owner, and the ports for connection (e.g., a HTTPS port). The ESM request is then transmitted to the poller managing system 124 where the ESM information will be stored and the ESM connection status updated at block 506. The poller managing system 124 will then check its records to find if an available poller device is already facilitating an ESM connection between the source and the service functions 126. The data transmission may be performed either actively or passively by the poller service coordinator 126. In some embodiments, the poller service coordinator 126 may actively send the ESM request to the poller managing system 124. In some other embodiments, the poller service coordinator 126 may place the ESM request on a queue available to the poller managing system 124 which may periodically poll the request for further processing.

For FIG. 5, it is assumed that the requested connection has not been facilitated by an available poller device 112. Since there is not a poller device 112 currently facilitating the requested ESM connection, the poller managing system 124 will instruct the virtualized environment coordination service to allocate the indicated baseline amount of computing resources and initialize a poller device 112 program on the computing resources at block 508. In some embodiment, a poller instance 114 may also be spawned before any data transmission workload has been assigned. Then at block 510, information regarding the initialized poller device 112 is returned to the poller managing system 124 to update the records. In some embodiments, the records at the poller managing system may include, for each ESM connection, the operation status of the currently available poller devices 112, the poller instance 114 spawned on each poller device 112, the workload assignments to each poller instance 114, and the assignment status.

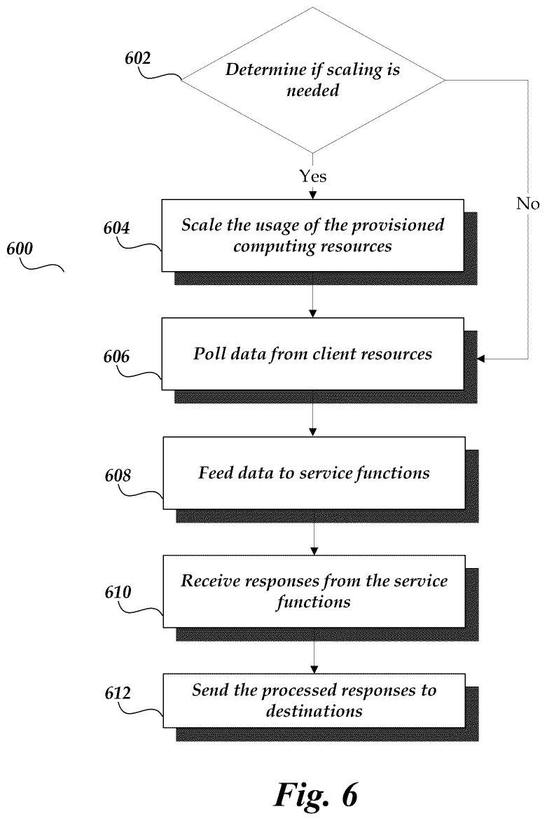

With reference to FIG. 6, an illustrative routine 600 will be described for utilizing a poller device 112 for handling data transmission workload. The routine may be implemented on the poller device 112, or the poller instance 114. It is assumed in FIG. 6 that an ESM connection as previously described has already been established and a poller device 112 has been initialized. It is further assumed that at least one poller instance 114 has been spawned on the poller device 112.

The routine 600 begins at block 602 where the poller device 112 determines, based on its current workload, if more computing resources should be used. Moreover, such scaling logic may, in some embodiments, be separately implemented in the poller environment 216, the poller agent environment 218, and the invoker environment 220 where each of the environment decides for itself if more resources should be used or released based on its current workload. In some other embodiments, the resource usage or instance spawning logic may be implemented at the poller agent environment 218 only, where the poller agent environment 218 monitors the operational status of the invoker environment 220 and the poller environment 216 and makes scaling decisions accordingly. The logic can determine that scaling is needed, for example, when the number of congesting assignments reaches a threshold or when computing resources utilization rates reach a certain level. If scaling is needed, at block 604, the poller device 112 scales its resource usage accordingly. As previously described, this may be accomplished by either spawning more poller instances 114, or more instances of the functional environments like the poller environment 216 or allocating more computing resources to the current instances on the poller device 112.

If scaling is not needed, or if the scaling has been completed, then at block 606, the poller instance 114 starts polling data from the client virtual network environment 130. In some embodiment, the poller instance 114 delegates the polling function to the poller environment 216, which may be implemented as, for example, a polling program image in a separate container, or a separate function with its own allocated computing resources. The poller instance 114 polls data via a client-facing interface 404 that may illustratively be a private connection, or a controlled public connection. In some embodiments, the poller instance 114 only starts polling data according to the received workload assignments from the poller managing system 124.

After the poller instance 114 polled data from the client virtual network environment 130, the poller instance 114 feeds the data to the target service functions 126 for further processing. In some embodiments, the invoking function is then carried out by an invoker environment 220. The invoker environment may be implemented as, for example, an image of an invoking program in a separate container, or a separate function with its own allocated computing resources. In some embodiments, the data transmission is facilitated by a service-facing interface 401 that is implemented as a private connection or a controlled public connection. The service functions 126 then process the data according to the predesignated logic and return the processed results to the poller 114. The poller instance 114 then relays the results to the designated destination.

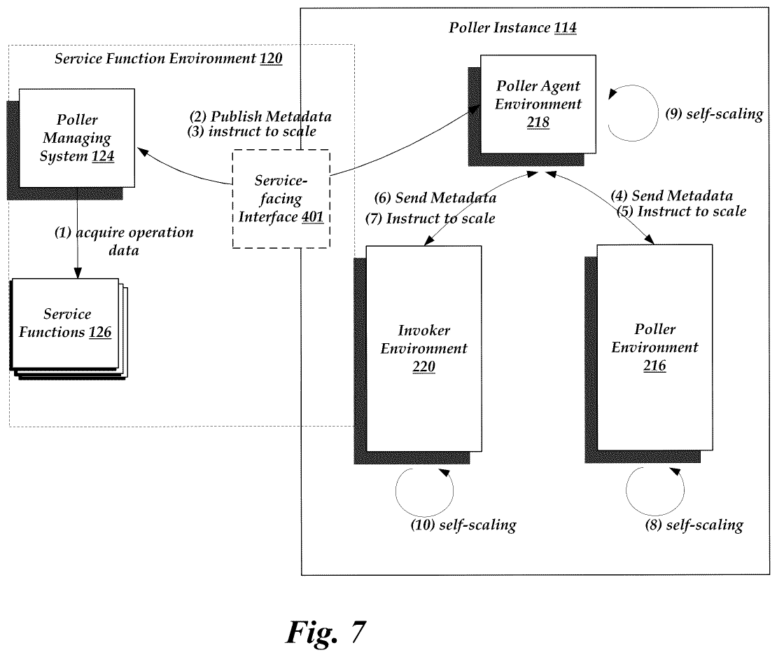

FIG. 7 is a flow diagram depicting illustrative interactions for scaling usage of computing resources. It is assumed in FIG. 4 that an ESM connection as previously described has already been established and a poller device 112 has been initialized. It is further assumed that at least one poller instance 114 has been spawned on the poller device 112. It should be noted for this diagram, the step numbers are for illustrative purposes only and do not limit the order of operations in actual runtime environments as scaling decisions can be triggered by events without following the specific order as illustrated in this diagram.

At step (1), the poller managing system 124 is in communication with the service functions, taking advantage of its location in the same service function environment 120. The poller managing system 124 acquires operational data from service functions 126 which may, for example, include states of operation, congestion level, and upcoming workload. As previously described, the poller managing system 124 also receives metadata from the poller agent environment 218 at (2). Based on the operational data from service functions 126 and the metadata published by 218, the poller managing system 124 generates instructions for the functional environments 218, 220, and 216 to scale their resource usages at (3). Illustratively, the instructions may include instructions for the functional environments to spawn more instances or instructions for the functional environments to initialize more computing resources to use. In response to receiving the instructions, the poller agent environment 218 either starts to scale if the instructions are directed to the poller agent environment 218 or passes the instructions to the poller environment 216 or the invoker environment 220 at (5) and (7).

The instructions passed by the poller agent environment 218 may further be based on the metadata published by the invoker environment 220 and the poller environment 216 at (4) and (6). In some embodiments, the poller agent environment 218 makes scaling decisions and generates scaling instructions without instructions from the poller managing system 124. In some other embodiments, the scaling instructions generated by the poller agent environment 218 are based on both the more recent metadata sent from the poller environment 216 and the instructions sent from the poller managing system 124. Similar to the instructions generated by the poller managing system 124, the instructions sent by the poller agent environment 218 may include both the instructions to spawn and instructions to initialize more computing resources.

In some embodiments of the current disclosure, each of the three functional environments 216, 218, and 220 implements scaling logic based on the environment's own workload. At (8), (9), and (10), the poller environment 216, the poller agent environment 218, and the invoker environment 220 respectively determine whether scaling is needed based on its own current workload. In some implements, the scaling decisions are included as part of the metadata sent to the poller agent environment 218. Illustratively, the scaling decisions can be either decisions to spawn more instances of the environment, or decisions to initialize more computing resources.

It should be noted that in some embodiment, all these scaling instructions/decisions are bound by the range of available computing resources as provisioned according to the user indication previously described.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of customer computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable customer computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without customer input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of customer computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable customer computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without customer input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

Any routine descriptions, elements or blocks in the flow diagrams described herein and/or depicted in the attached figures should be understood as potentially representing modules, segments, or portions of code which include one or more executable instructions for implementing specific logical functions or elements in the routine. Alternate implementations are included within the scope of the embodiments described herein in which elements or functions may be deleted, or executed out of order from that shown or discussed, including substantially synchronously or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system configured to poll data from data sources, the system comprising:
a client virtual network environment configured to generate or transmit a request for further processing;
a service function environment configured to execute service functions in response to the request to perform further processing on the request; and
a provisioned poller device communicatively coupled to the client virtual network environment and the service function environment, the provisioned poller device comprising one or more poller instances, each of the one or more poller instances comprising:
a first environment in communication with the client virtual network environment, the first environment configured to:
read data from the client virtual network environment; and
automatically scale utilization of computing resources based on workloads of the first environment; and
a second environment in communication with the first environment and the service function environment, the second environment configured to:
receive data from the first environment;
transmit the data to the service functions in the service function environment for further processing; and
automatically scale utilization of computing resources based on workloads of the second environment.

2. The system of claim 1, wherein the first and second environments are further configured to scale computing resources usage according to an operational status of the client virtual network environment or the service function environment.

3. The system of claim 1, wherein the second environment is configured to receive processed data from the service function environment.

4. The system of claim 3, wherein the second environment is configured to transmit the processed data to the first environment, and wherein the first environment is configured to transmit the processed data to a destination environment.

5. The system of claim 1, wherein the first and second environments are further configured to scale computing resources usage within a resource usage range comprising a pre-determined maximum and a baseline, wherein the baseline of the resource usage range is greater than zero or an amount sufficient to handle a sudden increase in workload without causing extra time to set up a new resource.

6. The system of claim 1, wherein each of the one or more poller instances further comprises a third environment configured to transmit an assigned workload to the first environment and cause the first environment to read data from the client virtual network environment according to the assigned workload.

7. The system of claim 6, wherein the third environment is configured to record metadata generated by the first environment.

8. The system of claim 7, wherein the third environment is configured to determine if scaling is needed for the first and second environments based at least in part on the metadata.

9. The system of claim 6, wherein the third environment is configured to communicate with a poller managing system to manage the assigned workload and a connection between the client virtual network environment and the service function environment.

10. The system of claim 1, wherein the first environment is configured to process the data polled from the client virtual network environment into data batches for further processing.

11. A method for polling data from data sources, the method comprising:
as implemented by one or more hardware processors configured to execute computer-readable instructions:
polling data, by a provisioned poller, from a client virtual network environment via a first environment of a poller instance;
scaling a first usage of computing resources by the first environment based at least in part on workloads of the first environment;
creating data batches from the data polled via the first environment;
transmitting the data batches, via a second environment of the poller instance, to one or more service functions in a service function environment for further processing; and
scaling a second usage of computing resources by the second environment based at least in part on workloads of the second environment.

12. The method of claim 11, wherein the first and second environments are respectively implemented within network boundaries of the client virtual network environment or the service function environment.

13. The method of claim 11, further comprising receiving responses from the one or more service functions and sending the responses to a data destination.

14. The method of claim 13, further comprising scaling the first and second environments'computing resources usages within a resource usage range comprising a pre-determined maximum and a baseline, wherein the baseline of the resource usage range is greater than zero or an amount sufficient to handle a sudden increase in workload without causing extra time to set up a new resource.

15. The method of claim 11, further comprising:
polling workload assignments from a poller managing system; and
polling data from the client virtual network environment according to the workload assignments.

16. One or more non-transitory computer-readable media comprising instructions that, when executed by a computing system, cause the computing system to:
poll data, via a provisioned poller, from a client virtual network environment via a first environment of a poller instance;
scale a first utilization of computing resources by the first environment based at least in part on workloads of the first environment;
create data batches out of the polled data;
transmit the data batches, via a second environment of the poller instance, to service functions in a service function environment for further processing; and
scale a second utilization of computing resources by the second environment based at least in part on workloads of the second environment.

17. The one or more non-transitory computer-readable media as recited in claim 16, wherein the instructions cause the computing system to manage the first and second utilization of computing resources by the first and second environments of the poller instance.

18. The one or more non-transitory computer-readable media as recited in claim 17, wherein the instructions cause the computing system to receive an indication of a baseline amount of computing resources provisioned for a poller device comprising the poller instance.

19. The one or more non-transitory computer-readable media as recited in claim 18, wherein the instructions cause the computing system to scale the first and second utilization of computing resources by the first and second environments of the poller instance, wherein the poller device runs on at least the baseline amount of computing resources.

20. The one or more non-transitory computer-readable media as recited in claim 18, wherein the instructions cause the computing system to scale utilization of computing resources by the poller device based at least in part on workloads of the poller device.
